(19) United States
(12) Patent Application Publication
(10) Pub. No.: US 2018/0122537 A1
(43) Pub. Date: May 3, 2018

(54) ELECTRONIC COMPONENT

(71) Applicant: Murata Manufacturing Co., Ltd., Nagaokakyo-shi (JP)

(72) Inventors: Satoru SENTOKU, Nagaokakyo-shi (JP); Tadamasa MIURA, Nagaokakyo-shi (JP)

(21) Appl. No.: 15/859,786

(22) Filed: Jan. 2, 2018

Related U.S. Application Data
(63) Continuation of application No. PCT/JP2016/067840, filed on Jun. 15, 2016.

(30) Foreign Application Priority Data
Jul. 15, 2015 (JP) 2015-141033

(51) Int. Cl. H01C 1/084; H01C 7/00; H01C 1/144; H01C 1/01; H01C 1/028; G01K 7/22; G01K 1/12

(52) U.S. Cl. CPC H01C 1/084; H01C 7/008; H01C 1/144; G01K 1/12; H01C 7/006; H01C 1/028; G01K 7/22; H01C 1/01

(57) ABSTRACT

An electronic component includes a temperature sensor including a pair of electrodes, at least one metal block electrically connected to an electrode of the temperature sensor, an insulation portion in which the temperature sensor and the at least one metal block are embedded, and an external terminal electrically connected to the electrode of the temperature sensor. The at least one metal block includes a flat surface exposed from the insulation portion. The flat surface defines the external terminal.

### CROSS REFERENCE TO RELATED APPLICATIONS

This application claims the benefit of priority to Japanese Patent Application No. 2015-141033 filed on Jul. 15, 2015 and is a Continuation Application of PCT Application No. PCT/JP2016/067840 filed on Jun. 15, 2016. The entire contents of each application are hereby incorporated herein by reference.

### BACKGROUND OF THE INVENTION

### 1. Field of the Invention

The present invention relates to an electronic component provided with a temperature sensor.

### 2. Description of the Related Art

An electronic component provided with a temperature sensor is used in a wide variety of applications, such as a temperature detection application and a temperature compensation application. In recent years, temperature sensors having smaller and thinner sizes have been required in association with miniaturization and thinning of electronic devices. The temperature sensors having various configurations have been developed to achieve miniaturization and thinning of the temperature sensors.

JP 2012-119389 A discloses a thin film thermistor having a resistance value which is decreased as temperature is increased. The thin film thermistor described in JP 2012-119389 A includes a substrate, a first insulating film 3 (a functional film) provided on the substrate, a pair of electrode films 41, 42 (both functional films) disposed on the first insulating film 3, a thermistor film 5 (a functional film) provided on the electrodes 41 and 42, a pair of pad electrodes 71, 72 extending from the pair of electrodes 41 and 42, respectively and a protective film 6 (a functional film) covering the thermistor film 5.

Such an electronic component is attached to an electronic device by laser welding (bonding) or the like at the pad electrode portions. However, heat generated during the laser welding may be transferred to a temperature sensor inside the electronic component to deteriorate a property of the temperature sensor. The deterioration of the temperature sensor caused by the heat may be especially remarkable when the temperature sensor having high sensitivity is used. On the other hand, a temperature sensor having smaller size and higher sensitivity has been required in association with miniaturization and enhanced performance of electronic devices.

### SUMMARY OF THE INVENTION

Preferred embodiments of the present invention provide electronic components capable of being miniaturized, having a highly sensitive temperature detection function and capable of reducing or preventing the deterioration caused by the laser welding.

The present inventors discovered that an electronic component provided with a temperature sensor is able to achieve both miniaturization and a highly sensitive temperature detection function of the electronic component and to reduce or prevent deterioration due to laser welding by disposing a metal block having a large heat capacity inside the electronic component provided with the temperature sensor, and providing an external terminal with direct or indirect contact with the metal block, and thus provided preferred embodiments of the present invention.

According to a preferred embodiment of the present invention, an electronic component includes a temperature sensor including a pair of electrodes; at least one metal block electrically connected to the electrode of the temperature sensor; an insulation portion embedding the temperature sensor and the at least one metal block therein; and external terminals electrically connected to the electrodes of the temperature sensor, wherein the at least one metal block includes a flat surface exposed from the insulation portion, the flat surface defining the external terminals.

Electronic components according to preferred embodiments of the present invention are provided with the metal block having a large heat capacity, and thus, are able to reduce or prevent the deterioration of the temperature sensor caused by the heat generated during the laser welding even when the electronic component is miniaturized and where the temperature sensor having high sensitivity is used. Therefore, electronic components according to preferred embodiments of the present invention are able to be miniaturized, and have a highly sensitive temperature detection function, and are able to reduce or prevent the deterioration caused by the laser welding.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a perspective view of an electronic component according to a first preferred embodiment of the present invention.

FIG. 1B is a bottom view of the electronic component according to the first preferred embodiment of the present invention.

FIG. 1C is a perspective view of the electronic component according to the first preferred embodiment of the present invention in which an insulation portion is shows transparently.

FIGS. 2A to 2C are schematic views showing a manufacturing process of the electronic component according to the first preferred embodiment of the present invention.

FIG. 3A is a perspective view of an electronic component according to a second preferred embodiment of the present invention.

FIG. 3B is a bottom view of the electronic component according to the second preferred embodiment of the present invention.

FIG. 3C is a perspective view of the electronic component according to the second preferred embodiment of the present invention in which an insulation portion is shown transparently.

FIGS. 4A to 4C are schematic views showing a manufacturing process of the electronic component according to the second preferred embodiment of the present invention.

FIG. 5 is a schematic view of a cross section of an electronic component according to a third preferred embodiment of the present invention.

FIG. 6 is a schematic view of a cross section of an electronic component according to a fourth preferred embodiment of the present invention.

### DETAILED DESCRIPTION OF THE PREFERRED EMBODIMENTS

Hereinafter, preferred embodiments of the present invention will be described with reference to the drawings. The following preferred embodiments are intended for the purpose of illustration, and the present invention is not limited to the following preferred embodiments. Dimensions, materials, shapes, relative arrangements and other features and parameters of components described below are merely illustrative examples, and the scope of the present invention is not intended to be limited only to those unless specifically described. Sizes, shapes, positional relations and other features and parameters of components shown in the respective drawings may be exaggerated for clarifying explanations.

### First Preferred Embodiment

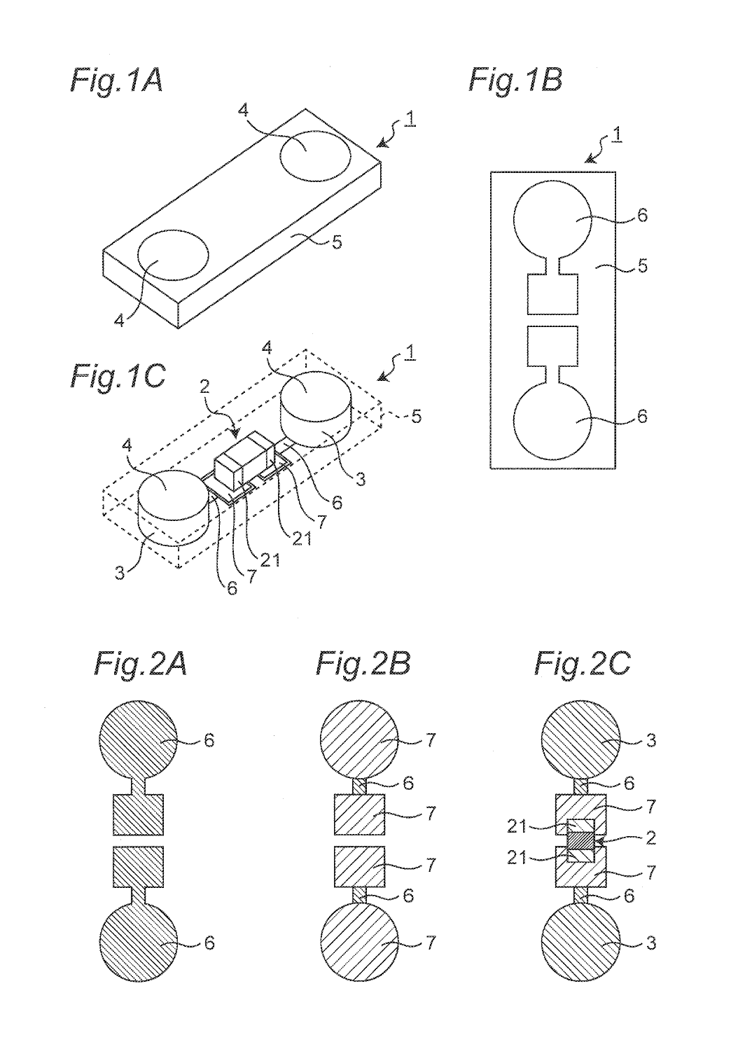

FIGS. 1A to 1C shows an electronic component according to a first preferred embodiment of the present invention. FIG. 1A is a perspective view of the electronic component according to this preferred embodiment. FIG. 1B is a bottom view of the electronic component according to this preferred embodiment. FIG. 1C is a perspective view of the electronic component according to this preferred embodiment in which an insulation portion is shown transparently. The electronic component 1 shown in FIGS. 1A to 1C includes a temperature sensor 2 including a pair of electrodes 21; at least one metal block 3 electrically connected to the temperature sensor 2; an insulation portion 5 embedding the temperature sensor 2 and the at least one metal block 3 therein; and a pair of external terminals 4 electrically connected to the electrodes 21 of the temperature sensor 2.

The temperature sensor 2 is not particularly limited as long as it includes a pair of electrodes 21, and the temperature sensor 2 may be appropriately selected according to targeted application. As the temperature sensor 2, for example, a metal temperature-measuring resistor, such as a platinum thin-film temperature sensor and a thermistor, may be used. The temperature sensor 2 is preferably a thermistor chip since it is able to provide an electronic component having a highly sensitive temperature detection function at low cost. The thermistor chip may be any of a positive temperature coefficient thermistor (a PTC thermistor) and a negative temperature coefficient thermistor (a NTC thermistor), for example.

The electronic component includes at least one metal block. The electronic component 1 shown in FIGS. 1A to 1C includes two metal blocks 3. However, electronic components according to preferred embodiments of the present invention are not limited to such a configuration, and the electronic component may include only one metal block, or may include three or more metal blocks. The metal block 3 is electrically connected to the electrode 21 of the temperature sensor 2. In the electronic component 1 shown in FIGS. 1A to 1C, the metal blocks 3 are electrically connected to the electrodes 21 of the temperature sensor 2 via conductor wirings 6. However, the present invention is not limited to such a configuration.

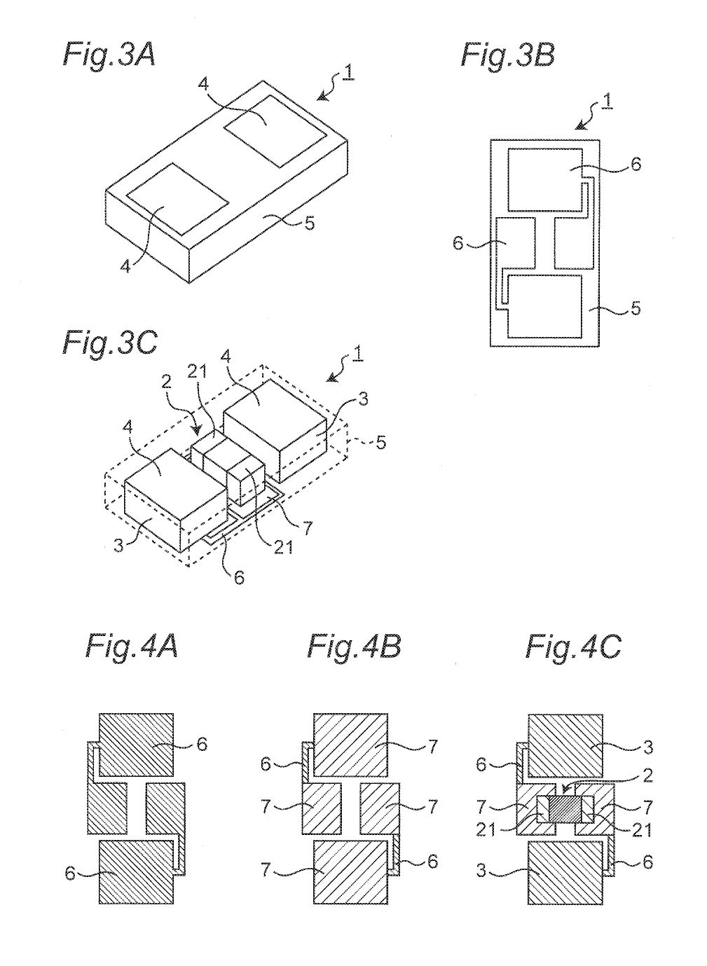

The metal block 3 includes a flat surface exposed from an insulation portion 5 described later, and the flat surface defines the external terminals 4. The flat surface defines a joint portion during the laser welding described later, and thus, the flat surface is preferably a uniform surface having high adhesion to a substance to be welded. However, the flat surface is not limited to such a surface and may be a curved surface and/or a concave-convex surface, and the flat surface may also include a mark or the like provided thereon as a reference for alignment upon welding as long as it does not interfere with the laser welding. The shape of the metal block 3 is not particularly limited as long as the metal block 3 has the flat surface described above, and it may be, for example, a shape such as a columnar shape having a polygonal bottom surface, such as a triangular prism and a quadrangular prism; a polygonal pyramid; a circular cone; and a bell shape, besides a cylindrical or substantially cylindrical shape as shown in FIGS. 1A to 1C and a rectangular or substantially rectangular parallelepiped shape as shown in FIGS. 3A to 3C. When the electronic component includes two or more metal blocks, shapes and dimensions of the respective metal blocks may be the same or substantially the same as each other or may be different from each other. In the electronic component 1 shown in FIGS. 1A to 1C, each of the metal blocks 3 includes a flat surface (an upper surface) exposed from an upper surface of the insulation portion 5, and the flat surface defines the external terminals 4. In the electronic component 1 shown in FIGS. 1A to 1C, the upper surfaces of the metal blocks 3 also define the external terminals 4. However, the electronic components according to preferred embodiments of the present invention are not limited to such a configuration, and, for example, another metal block or other similar structure to define the external terminals may further be joined to the upper surface of the metal block 3.

The electronic component 1 is attached to an electronic device or the like by, for example, laser welding with a ribbon strap made of an aluminum alloy or other suitable material at the external terminals 4. The electronic component 1 according to the present preferred embodiment enables the laser welding to be conducted on a surface different from a surface on which the temperature sensor 2 is mounted since the flat surface (upper surface) of the metal block 3 defines the external terminals 4. In addition, the external terminals 4 on which the laser welding is conducted are defined by the flat surface (upper surface) of the metal block having a large heat capacity, and thus, the heat generated during the laser welding is able to be prevented from being transferred to the temperature sensor 2. As a result, the deterioration of the temperature sensor 2 caused by the heat is able to be effectively reduced or prevented. This effect is particularly remarkable when the temperature sensor 2 has highly sensitive temperature detection function, and therefore, when the temperature sensor 2 has relatively low heat resistance. Since the external terminals 4 on which the laser welding is conducted are defined by the flat surface (upper surface) of the metal block 3 having a large heat capacity, the heat generated by the laser welding is able to be prevented from being transferred to the temperature sensor 2 even when the electronic component 1 is miniaturized. Therefore, the electronic component according to the present preferred embodiment is able to achieve both miniaturization and highly sensitive temperature detection function of the electronic component and of reducing or preventing deterioration caused by the laser welding.

Preferably, the dimension of the metal block 3 is sufficiently large as compared with the dimension of the temperature sensor 2. In this case, the heat generated during the laser welding is able to be further prevented from being transferred to the temperature sensor 2. When the temperature sensor 2 and the metal block 3 are connected to a conductor wiring 6 via a conductive connection material 7 as described later, the conductive connection material 7 is able to be effectively prevented from suffering an adverse effect caused by the heat during the laser welding. The adverse effect includes, for example, an occurrence of so-called splash failure (a phenomenon of a flux contained in a solder paste being scattered) during the laser welding in a case in which the solder paste is used as the conductive connection material 7. The occurrence of the splash failure is able to be effectively reduced or prevented by setting the dimension of the metal block 3 as described above. Furthermore, when the dimension of the metal block 3 is sufficiently large as compared to the dimension of the temperature sensor 2, the heat generated during the laser welding is able to be effectively prevented from being transferred to the insulation portion 5, and thus, the deterioration of the insulation portion 5 caused by the heat such as, for example, the deterioration of a resin component, such as epoxy resin included in the insulation portion 5 caused by the heat is able to be effectively reduced or prevented. The volume of the metal block 3 may be appropriately adjusted in light of the dimension of the temperature sensor 2, the dimension of the electronic component 1 itself, welding conditions, such as a temperature during the laser welding, laser irradiation diameter and irradiation time and the like. As an example, in a case in which the laser irradiation diameter is about 0.07 mm and the irradiation time of about 20 ms during the laser welding and the temperature during the laser irradiation of about 1,100° C., the volume of the metal block 3 is preferably 1.0 mm³ or more.

It is preferable to adjust an area of the flat surface of the metal block 3 defining the external terminal 4 in accordance with the irradiation diameter of the laser used in the laser welding and the temperature during the laser irradiation. When the flat surface (upper surface) of the metal blocks 3 also defines the external terminals 4 as shown in FIGS. 1A to 1C, the area of the flat surface (upper surface) of the metal block 3 is an area of the external terminal 4. Specifically, the flat surface of the metal block 3 preferably has a larger area as the irradiation diameter of the laser is increased, and the flat area preferably has a larger area as the temperature during the laser irradiation is increased. The generated heat is able to be effectively prevented from being transferred to the temperature sensor 2 by setting the area in such a manner. For example, when the metal block 3 includes Cu, the laser welding is conducted at a temperature higher than the melting point of Cu (1085° C.). As an example, in a case of the laser irradiation diameter during the laser welding of about 0.07 mm and the temperature during the laser irradiation of about 1,100° C., the area of the flat surface of the metal block 3 defining the external terminal 4 is preferably about 1.0 mm² or more.

The height of the metal block 3 is preferably larger than the height of the temperature sensor 2. The heat generated during the laser welding on the external terminals 4 is able to be further prevented from being transferred to the temperature sensor 2 by setting the height of the metal block 3 in such a manner. When the temperature sensor 2 and the metal block 3 are electrically connected to the conductor wiring 6 via the conductive connection material 7, the distance between the external terminals 4 and the mounting surface of the temperature sensor 2 and the metal blocks 3 is able to be increased by the height of the metal blocks 3 being larger than the height of the temperature sensor 2. As a result, the conductive connection material 7 is able to be effectively prevented from suffering an adverse effect caused by the heat during the laser welding.

The arrangement of the metal block 3 in the electronic component 1 is not particularly limited as long as the metal block 3 and the temperature sensor 2 are arranged such that both are electrically connected to each other, and the arrangement can be set appropriately in accordance with the intended application. As the distance between the metal block 3 and the temperature sensor is larger, the heat is less likely to be transferred to the temperature sensor 2, and thus, the deterioration of the temperature sensor 2 caused by the heat is able to be reduced or prevented. When the temperature sensor 2 and the metal block 3 are connected to the conductor wiring 6 via the conductive connection material 7, the heat is less likely to be transferred to the mounting surface as the distance between the metal block and the temperature sensor is larger, and thus, the conductive connection material 7 is able to be effectively prevented from suffering the adverse effect caused by the heat during the laser welding. On the other hand, in a case of miniaturizing the electronic component 1, it is preferable to decrease the distance between the metal block 3 and the temperature sensor 2 to some extent. In the electronic component 1 according to the present preferred embodiment, the heat is less likely to be transferred to the temperature sensor 2 even when the distance between the metal block 3 and the temperature sensor 2 is relatively small, since the external terminal 4 on which the laser welding is conducted is defined by a surface of the metal block having a large heat capacity. Accordingly, the deterioration of the temperature sensor 2 caused by the heat is able to be effectively reduced or prevented. In addition, the conductive connection material 7 is able to be effectively prevented from suffering an adverse effect caused by the heat during the laser welding since the heat is less likely to be transferred to the mounting surface. The distance between the metal block 3 and the temperature sensor 2 and the arrangement of the metal block 3 and the temperature sensor 2 are able to be adjusted appropriately in view of the type and the dimension of the temperature sensor 2 and the dimension of the metal block 3 and the like. For example, the electronic component includes two or more metal blocks 3, and it is preferable to dispose the two or more metal blocks 3 around the temperature sensor 2. Both of the reduced or prevented deterioration caused by the heat and the miniaturization and high sensitivity of the electronic component 1 are able to be achieved by disposing the metal blocks 3 in this manner.

The electronic component 1 shown in FIGS. 1A to 1C includes two metal blocks 3, and the two metal blocks 3 are disposed so as to sandwich the temperature sensor 2 in a direction parallel or substantially parallel to a direction from one electrode 21 toward the other electrode 21 of the temperature sensor 2. With such an arrangement, a temperature sensor meeting various laser welding conditions (such as irradiation intensity and irradiation time of laser) is able to be easily provided while maintaining a temperature responsiveness of the temperature sensor 2 only by changing the height of the metal block 3 and the height of the electronic component 1 itself. The electronic component 1 shown in FIGS. 1A to 1C includes two metal blocks 3. However, the electronic component according to the present preferred embodiment may further include one or more additional metal blocks.

A metal material defining the metal block 3 is not particularly limited, and may include, for example, metals such as Cu, Fe, Al, Ti, V, Cr, Mn, Co, Ni, Zn, Mo, Ru, Pd, Ag, W, Pt and Au, metal alloys thereof and other suitable materials. The deterioration of the temperature sensor 2 caused by heat is able to be effectively reduced or prevented as the metal material included in the metal block 3 has larger heat capacity. In addition, the conductive connection material 7 is able to be effectively prevented from suffering an adverse effect by heat during the laser welding. The metal block 3 preferably includes copper or copper alloy each of which has relatively large heat capacity. For example, the metal block 3 preferably includes oxygen-free copper C1020, tough pitch copper C1100, phosphorous-deoxidized copper C1220 and other suitable copper. When the electronic component includes two or more metal blocks, each of the metal blocks may be made of the same metal material, or may be made of different types of metal materials.

The metal block 3 may be manufactured by a method such as rolling, metal press and etching. It is preferable to conduct a surface treatment, such as rust-proofing and/or plating (such as Ni/Sn plating) of the metal block 3, in order to prevent the metal block 3 from being oxidized during storage and during the manufacturing process. However, such surface treatment is not indispensable. When the flat surface of the metal block 3 also defines the external terminal 4, a plating layer, such as a Ni plating layer and/or an Au plating layer, may preferably be provided on this flat surface, for example. The surface of the metal block is protected from humidity and contamination, such as corrosive gas, by providing such plating layer, and thus, a joint reliability by welding is able to be improved.

The electronic component 1 includes the insulation portion 5 embedding the temperature sensor 2 and the metal block 3. The insulation portion 5 is provided to protect the temperature sensor 2 from an external environment. A material defining the insulation portion 5 is not particularly limited as long as it has an insulation property, and it may include, for example, a thermosetting resin such as an epoxy resin, a phenol resin, a silicone resin, a polyimide resin, a bismaleimide resin, a urea resin and a melamine resin; an insulating glass material such as a glass ceramics; an insulating substrate material such as alumina; and other suitable materials. The insulation portion 5 is preferably made of a material having high heat resistance in order to improve a resistance to a thermal stress which may occur during the welding.

The temperature sensor 2 and the metal block 3 may be disposed on the conductor wiring 6 which electrically connects the temperature sensor 2 and the metal block 3. The conductor wiring 6 may be, for example, a copper foil pattern, an electric wire such as a copper wire, a wiring of copper, silver alloy or the like formed on a circuit board, or other suitable conductive materials. In this case, a surface of the metal block 3 in contact with the conductor wiring 6 is preferably opposed at least partially to the flat surface of the metal block 3 (the surface defining the external terminal 4). Such a configuration is able to effectively prevent the heat generated during the laser welding from being transferred to the temperature sensor 2, and thus, the deterioration of the temperature sensor 2 by the heat is able to be effectively reduced or prevented. In addition, when the temperature sensor 2 and the metal block 3 are connected to the conductor wiring 6 via the conductive connection material 7, the configuration described above is able to effectively prevent the conductive connection material 7 from suffering an adverse effect by the heat during the laser welding. In the present specification, one surface “opposed at least partially” to another surface of the metal block 3 means a state in which the one surface overlaps at least partially with the another surface as viewing the metal block 3 from above.

The temperature sensor 2 and the metal block 3 are preferably connected to the conductor wiring 6 via the conductive connection material 7. The electronic component 1 may be manufactured with a simple method by the connection of the temperature sensor 2 and the metal block 3 to the conductor wiring 6 in this manner. As the conductive connection material 7, for example, a solder (a solder paste), a flux, a conductive adhesive, an anisotropic conductive adhesive sheet or other suitable material may be used.

At least a portion of the conductor wiring 6 is preferably exposed on an outer surface of the electronic component 1. Such a configuration improves the responsiveness of the temperature sensor 2. When at least a portion of the conductor wiring 6 is exposed on the outer surface of the electronic component 1, a plating layer, such as a Ni plating layer and/or an Au plating layer, for example, may preferably be provided on the exposed surface. The surface of the conductor wiring is protected from humidity and contamination, such as corrosive gas by providing such plating layer, and thus the life of the product is able to be improved. In addition, when such surface is brought into contact with an object to be measured to be used as a sensor, the plating layer contributes to improved reliability of measurement accuracy.

An area of a land portion of the conductor wiring 6 is preferably larger than the total of areas of the mounting surfaces of the temperature sensor 2 and the metal block 3. Such configuration increases an area of the conductor wiring 6 in contact with the object to be measured. Heat conductivity between the object to be measured and the temperature sensor 2 is improved as the area of the conductor wiring 6 in contact with the object to be measured is increased, and as a result, the responsiveness of the temperature sensor 2 is improved.

A non-limiting example of a method for manufacturing the electronic component 1 according to the present preferred embodiment will be described below with reference to FIGS. 2A to 2C. However, the method for manufacturing the electronic component according to the present preferred embodiment is not limited to the method described below.

First, for example, a dry film resist (PHOTEC-RY3237 manufactured by Hitachi Chemical Company, Ltd.) is attached by a laminator on a mother Cu foil having a thickness of about 18 μm, and lithographic exposure and image development are conducted to form openings at portions corresponding to mounting portions of the temperature sensor 2 and the metal block 3 and a portion corresponding to a connection portion between the temperature sensor 2 and the metal block 3, respectively of the dry film resist on the mother Cu foil. As the resist, a liquid resist is able to also be used instead of the dry film resist.

Then, at the openings of the resist, a Cu plating layer, a Ni plating layer, and a Sn plating layer are sequentially formed on the mother Cu foil by electrolytic plating or other suitable plating process to form the conductor wiring 6 (FIG. 2A). When a solder paste is used as the conductive connection material, it is preferable to provide the plating layer to improve the joint reliability. However, in a case of using the other conductive connection material, the plating layer may be omitted.

Then, a solder paste (M705-GRN360-K2-V manufactured by Senju Metal Industry Co., Ltd.) as the conductive connection material 7 is applied on the mounting surfaces of the temperature sensor 2 and the metal block 3 on the conductor wiring 6 (FIG. 2B). The temperature sensor 2 and the metal block 3 are mounted on the conductive connection material 7, and heated in a reflow furnace to connect the temperature sensor 2 and the metal block 3 to the conductor wiring 6 (FIG. 2C).

Then, for example, four sheets of uncured resin sheets made of a thermosetting epoxy resin having a thickness of about 100 μm are laid on top of one another, and pressure-bonded to the temperature sensor 2 and the metal block 3 from mounted surfaces thereof to seal the temperature sensor 2 and the metal block 3 inside the insulating resin material. The insulating resin material is a material defining the insulation portion 5. The pressure bonding may be conducted at a pressure of about 5 MPa for about three minutes after vacuuming at a temperature of about 130° C. for about two minutes, for example. A thickness of the insulating resin material after the pressure bonding may be, for example, about 300 μm. The pressure bonding described above is usually conducted using a press molding having a flat shape at its lower surface. Therefore, the upper surface (pressure-bonding surface) of the insulating resin material is formed into a flat shape.

The insulating resin material after the pressure bonding, and the temperature sensor 2 and the metal block 3 sealed therein are placed in an oven and heated to cure the insulating resin material. The heating may be conducted, for example, at a temperature of about 180° C. for about 60 minutes.

Then, the upper surface (pressure-bonding surface) of the insulating resin material is polished to expose one surface of the metal block 3. This exposed surface defines the external terminal 4. The polishing may not be conducted in cases where one surface of the metal block 3 is sufficiently exposed at the upper surface of the insulating resin material after the pressure bonding and where the insulating resin material covering the upper surface of the metal block 3 is thin enough to be removed easily by tweezers or other suitable methods.

Then, a Cu foil is formed on the reverse sides of the mounted surfaces of the temperature sensor 2 and the metal block 3 by a subtractive method, such as etching of the mother Cu foil, for example. Subsequently, a Ni plating layer and an Au plating layer are sequentially formed by electrolytic plating or other suitable plating process on the surface of the metal block 3 exposed by the polishing or the like and on the surface of the Cu foil formed on the reverse sides of the mounted surfaces of the temperature sensor 2 and the metal block 3.

Subsequently, the insulating resin material is cut with a cutting machine, such as a clicker cutter and a dicer processing machine, to obtain a piece of the electronic component 1 including the temperature sensor 2 and the metal block 3 embedded in the insulation portion 5.

### Second Preferred Embodiment

Next, an electronic component according to a second preferred embodiment of the present invention will be described below with reference to FIGS. 3A to 3C. In the second preferred embodiment and third and fourth preferred embodiments described later, descriptions about the matters in common with the first preferred embodiment will be omitted, and only a point different from the first preferred embodiment will be described. In particular, a similar effect caused by a configuration similar to that of the first preferred embodiment is not mentioned point by point in the second to fourth preferred embodiments. However, the electronic components according to the second to fourth preferred embodiments produce effects the same as or similar to those produced by the electronic component according to the first preferred embodiment unless specifically explained. The electronic component 1 according to the second preferred embodiment includes two metal blocks 3 and has a configuration similar to that of the electronic component according to the first preferred embodiment, except that the two metal blocks 3 are disposed so as to sandwich the temperature sensor 2 in a direction perpendicular or substantially perpendicular to a direction from one electrode 21 toward the other electrode 21 of the temperature sensor 2. Since the electronic component according to the second preferred embodiment has such a configuration, the distance between the external terminal 4 and the mounting surface of the temperature sensor 2 is able to be increased even when the electronic component 1 is miniaturized. Accordingly, the deterioration of the temperature sensor 2 caused by the heat generated during the laser welding is able to be effectively reduced or prevented. In addition, when the temperature sensor 2 and the metal blocks 3 are connected to the conductor wiring 6 via the conductive connection material 7, the conductive connection material 7 is able to be effectively prevented from suffering an adverse effect by the heat during the laser welding. Furthermore, when the sizes of the mounting land portions are the same or substantially the same, a fillet inspection of the metal blocks 3 is able to be conducted more easily by miniaturizing the size of the electronic component 1, and thus, the process management is facilitated. The electronic component 1 shown in FIGS. 3A to 3C includes two metal blocks 3. However, the electronic component according to the present preferred embodiment may further include one or more additional metal blocks. The metal blocks 3 shown in FIGS. 3A to 3C each preferably have a rectangular or substantially rectangular parallelepiped shape. However, the metal blocks may have other shapes, such as a cylindrical shape, for example.

The electronic component according to the present preferred embodiment may be manufactured by procedures similar to those of the electronic component according to the first preferred embodiment described above. Specifically, in accordance with procedures similar to those of the electronic component according to the first preferred embodiment, a conductor wiring 6 as shown in FIG. 4A is formed, a conductive connection material 7 is applied thereon as shown in FIG. 4B, then a temperature sensor 2 and a metal block 3 are mounted on the conductive connection material 7, and heated in a reflow furnace to connect the temperature sensor and the metal block 3 to the conductor wiring 6 (FIG. 4C). Subsequently, pressure bonding of the insulating resin material is conducted by procedures similar to those of the electronic component according to the first preferred embodiment, and thus, the electronic component 1 according to the second preferred embodiment is able to be obtained.

### Third Preferred Embodiment

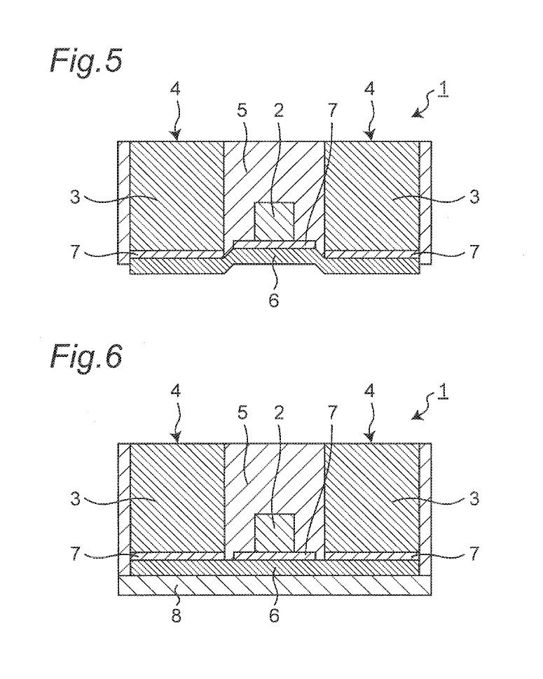

Next, the electronic component according to a third preferred embodiment of the present invention will be described below with reference to FIG. 5. The electronic component 1 according to the third preferred embodiment has a configuration similar to those of the electronic components according to the first and the second preferred embodiment, except that the conductor wiring 6 has a shape including a portion at which the metal block 3 is disposed protruding toward an outside of the electronic component 1 (convex shape) relative to a portion at which the temperature sensor 2 is disposed. In other words, the conductor wiring 6 has a concave shape at the portion at which the temperature sensor 2 is disposed. The electronic component according to the present preferred embodiment improves an adhesion of the temperature sensor 2 portion to the object to be measured having curved surface, since the electronic component has the configuration as described above. As a result, the responsiveness of the temperature sensor 2 is able to be improved. In the electronic component according to the present preferred embodiment, the arrangement of the temperature sensor 2 and the metal block 3 is not particularly limited, and it may be an arrangement as shown in FIGS. 1A to 1C or an arrangement as shown in FIGS. 3A to 3C, for example.

The electronic component 1 according to the present preferred embodiment may be manufactured by appropriately adjusting a pressure during the pressure bonding of the insulating resin material and/or conducting the pressure bonding with a press mold provided with a convex portion in the method for manufacturing the electronic component according to the first preferred embodiment.

### Fourth Preferred Embodiment

Next, the electronic component according to a fourth preferred embodiment of the present invention will be described below with reference to FIG. 6. The electronic component 1 according to the fourth preferred embodiment has a configuration similar to those of the electronic components according to the first and the second preferred embodiments, except that the conductor wiring 6 is disposed on an insulating substrate 8. The insulating substrate 8 is not particularly limited as long as it has an insulation property, and the insulating substrate 8 may be, for example, an alumina substrate, a glass-epoxy substrate, a flexible substrate, a glass-ceramic substrate or other suitable material. The electronic component 1 according to the present preferred embodiment has an advantage of being manufactured by a simple method. Specifically, the conductor wiring may preferably be formed by a method, such as a thick-film printing of a conductor paste on the insulating substrate. The electronic component 1 according to the present preferred embodiment may be manufactured by the simple process as compared to those of the first to the third preferred embodiment in which the conductor wiring is formed by plating and etching of the mother Cu foil as described above. In the electronic component according to the present preferred embodiment, the arrangement of the temperature sensor 2 and the metal block 3 is not particularly limited, and it may be an arrangement as shown in FIGS. 1A to 1C or an arrangement as shown in FIGS. 3A to 3C.

### EXAMPLES

Examples of electronic components according to the first preferred embodiment were prepared by use of a thermistor chip having 1608 size (about 1.6×about 0.8×about 0.8 mm) as the temperature sensor and a copper block as the metal block. The copper block used had a cross-sectional area (an area of the flat surface) of about 0.50 mm² to about 3.14 mm² and a height of about 0.4 mm to about 2.0 mm. Laser welding (laser welding temperature: about 1,100° C., irradiation diameter: about 0.07 mm, irradiation time: about 20 ms) was conducted for each of the electronic components, and temperature data of the thermistor chips immediately after the laser welding were obtained. The results are shown in Table 1. It can be seen from Table 1 that the temperature of the thermistor chip immediately after the laser welding was decreased as the cross-sectional area of the copper block was increased. It can also be seen that the temperature of the thermistor chip immediately after the laser welding was decreased as the height of the copper block was increased. It can be seen from those results that the heat generated during the laser welding was prevented from being transferred to the thermistor chip by appropriately setting the dimension of the copper block, and thus, the heat stress to the thermistor chip was reduced or prevented to a sufficiently low level. Therefore, the deterioration of the temperature sensor caused by the heat generated during the laser welding is considered to be reduced or prevented by appropriately setting the dimension of the copper block.

TABLE 1
(Unit: ° C.)

| | Cross-sectional | | | |
|---|---|---|---|---|
| | area (mm²) | | | |
| Height (mm) | 0.50 | 1.13 | 2.01 | 3.14 |
| 0.4 | 821 | 612 | 457 | 367 |
| 0.6 | 662 | 473 | 318 | 246 |
| 0.8 | 559 | 383 | 240 | 184 |
| 1.0 | 492 | 310 | 205 | 150 |
| 1.2 | 409 | 259 | 169 | 129 |
| 1.4 | 345 | 219 | 144 | 110 |
| 1.6 | 290 | 193 | 125 | 96 |
| 1.8 | 257 | 168 | 111 | 84 |
| 2.0 | 220 | 145 | 97 | 76 |

The electronic components according to preferred embodiments of the present invention are able to achieve both miniaturization and highly sensitive temperature detection function and a reduction or prevention of the deterioration by laser welding, and thus, are able to be used in electronic devices which require miniaturization and enhanced performance.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electronic component comprising:
a temperature sensor including a pair of electrodes;
at least one metal block electrically connected to one of the pair of electrodes of the temperature sensor;
an insulation portion embedding the temperature sensor and the at least one metal block therein; and
a pair of external terminals electrically connected to the pair of electrodes of the temperature sensor; wherein
the at least one metal block includes a flat surface exposed from the insulation portion, the flat surface defining the external terminals.

2. The electronic component according to claim 1, wherein a height of the metal block is larger than a height of the temperature sensor.

3. The electronic component according to claim 1, wherein
the temperature sensor and the metal block are disposed on a conductor wiring electrically connecting the temperature sensor and the metal block; and
a surface of the metal block in contact with the conductor wiring is at least partially opposed to the flat surface of the metal block.

4. The electronic component according to claim 3, wherein the temperature sensor and the metal block are connected to the conductor wiring via a conductive connection material.

5. The electronic component according to claim 3, wherein at least a portion of the conductor wiring is exposed at an outer surface of the electronic component.

6. The electronic component according to claim 3, wherein an area of a land portion of the conductor wiring is larger than a total of areas of mounting surfaces of the temperature sensor and the metal block.

7. The electronic component according to claim 3, wherein the conductor wiring has a shape including a portion at which the metal block is disposed protruding toward an outside of the electronic component relative to a portion at which the temperature sensor is disposed.

8. The electronic component according to claim 3, wherein the conductor wiring is disposed on an insulating substrate.

9. The electronic component according to claim 1, wherein
the at least one metal block includes two or more metal blocks; and
the two or more metal blocks are disposed around the temperature sensor.

10. The electronic component according to claim 1, wherein
the at least one metal block includes two metal blocks; and
the two metal blocks sandwich the temperature sensor in a direction parallel or substantially parallel to a direction from one electrode toward the other electrode of the temperature sensor.

11. The electronic component according to claim 9, wherein
the at least one metal block includes two metal blocks; and
the two metal blocks sandwich the temperature sensor in a direction perpendicular or substantially perpendicular to a direction from one electrode toward the other electrode of the temperature sensor.

12. The electronic component according to claim 1, wherein the metal block includes copper or copper alloy.

13. The electronic component according to claim 1, wherein the temperature sensor is a thermistor chip.

14. The electronic component according to claim 1, wherein the temperature sensor is a metal temperature-measuring resistor.

15. The electronic component according to claim 1, wherein the temperature sensor is one of a platinum thin-film temperature sensor and a thermistor.

16. The electronic component according to claim 1, wherein the at least one metal block has a cylindrical or substantially cylindrical shape.

17. The electronic component according to claim 1, wherein the at least one metal block has a rectangular or substantially rectangular parallelepiped shape.

18. The electronic component according to claim 1, wherein the at least one metal block includes at least one of Cu, Fe, Al, Ti, V, Cr, Mn, Co, Ni, Zn, Mo, Ru, Pd, Ag, W, Pt and Au, and metal alloys thereof.

19. The electronic component according to claim 1, wherein the at least one metal block includes oxygen-free copper C1020, tough pitch copper C1100, or phosphorous-deoxidized copper C1220.

20. The electronic component according to claim 1, wherein the insulation portion includes a thermosetting resin.
